(19) United States
(12) Patent Application Publication
(10) Pub. No.: US 2025/0001474 A1
(43) Pub. Date: Jan. 2, 2025

(54) CONVERTING WASTE PLASTIC INTO FUELS

(71) Applicant: Enerra Corporation, Bloomington, CA (US)

(72) Inventors: Sergio Alfredo PEREZ, Bloomington, CA (US); Timothy Michael ROBERGE, Bloomington, CA (US); Freddie Wayne PETERSON, Bloomington, CA (US)

(73) Assignee: Enerra Corporation, Bloomington, CA (US)

(21) Appl. No.: 18/756,913

(22) Filed: Jun. 27, 2024

Related U.S. Application Data
(60) Provisional application No. 63/511,006, filed on Jun. 29, 2023.

(51) Int. Cl. B09B 3/40; B09B 3/35; B09B 101/75

(52) U.S. Cl. CPC B09B 3/40; B09B 3/35; B09B 2101/75

(57) ABSTRACT

Described herein are plastic-to-fuel production systems and methods that provide a solution to the challenge of proper management of plastic waste. The disclosed techniques convert un-recycled plastic waste into ready-to-use, sustainably produced fuels in a concurrent process without the assistance of any catalyst materials. A Non-Catalytic Reformation System (NCR) system produces sustainable fuels such as diesel and gasoline, and other commodities such as paraffin and heavy diesel as well as a process gas (LPG) that is used to fuel the heaters serving the reformers in the NCR system to drive the process. By transforming waste into valuable resources, the techniques contribute to a circular economy where nothing may go to waste. This eco-friendly approach may also reduce reliance on fossil fuels by producing ready to use, sustainable fuels from plastic waste rather than fossil fuels and helps mitigate the environmental impact of plastic waste.

### CROSS REFERENCE TO RELATED APPLICATIONS

This application claims priority to U.S. Provisional Application No. 63/511,006, filed Jun. 29, 2023, which is hereby incorporated by reference in its entirety.

### FIELD

This disclosure relates to systems and methods for converting waste plastic into hydrocarbon fuels such as diesel fuel and gasoline.

### BACKGROUND

Plastic is a widely used synthetic material in the modern world. The use is wide and varied: from grocery bags to heavy machinery parts, from children's toys to commercial airlines, etc. Such wide usage invariably creates a large amount of waste. For example, over 30 million tons of plastic waste are dumped in the United States alone, with less than 10% of it being recycled. This creates a pressing environmental crisis, polluting our land and oceans. Decomposing plastic in landfills leaks potentially toxic chemicals into the ground and water supply. Additionally, clandestine plastic burning releases toxic gas into the atmosphere. An estimated eight million metric tons of plastic end up in the ocean every year. It has been reported in the news that 5.25 trillion pieces of plastic float on the ocean's surface, creating massive plastic islands. Consequently, plastic has been found in at least 180 marine species, including 100% of sea turtles. Additionally, microplastics have been found in rivers, mountains, oceans, and even in human digestive tracks.

Traditional recycling methods have limitations, leaving ninety percent or more of non-recyclable plastic that contributes to pollution. Therefore, a solution for managing plastic waste in an environmentally responsible manner is desired.

### SUMMARY

Embodiments disclosed solve the problem of plastic waste by using it to generate usable hydrocarbon fuels. These fuels are produced through a single and concurrent thermal physical process. First, the shredded plastic waste is super-heated and volatized in an oxygen free environment. Second, the gas created during the first stage is transferred to individualized condensing units and liquified into ready to use sustainable fuels and other products.

In an embodiment, a method of generating fuels from plastic waste is provided. The method may include preprocessing plastic waste. The method may also include mechanically introducing the preprocessed plastic waste into one or more reformers. The method may further include heating the preprocessed waste plastic in one or more reformers in a non-catalytic oxygen free environment to volatize the preprocessed plastic waste to a gas. The method may additionally include condensing the gas concurrently in a plurality of condensing units to generate a plurality of fuel types, each condensing unit generating a corresponding fuel type.

In one or more embodiments, a system is provided. The system may include one or more reformers configured to: receive a mechanically introduced preprocessed plastic waste and heat the preprocessed plastic waste in an oxygen free environment to volatize the preprocessed plastic waste to a gas. The system may also include a plurality of condensing units configured to: condense the gas concurrently in a non-catalytic process to generate a plurality of fuel types, each condensing unit generating a corresponding fuel type.

### BRIEF DESCRIPTION OF DRAWINGS

FIG. 1 shows an illustrative method of converting plastic waste to fuels, based on the principles disclosed herein.

FIG. 2 shows a system for converting plastic waste to fuels, based on the principles disclosed herein.

### DETAILED DESCRIPTION

Embodiments disclosed herein describe a plastic-to-fuel production system and methods that provide a practical solution to the challenge of plastic waste. The disclosed techniques convert un-recycled plastic waste into ready-to-use, sustainably produced fuels such as diesel and gasoline, and other commodities such as paraffin, heavy diesel, and liquid petroleum gas (LPG). By transforming waste into valuable resources, the techniques contribute to a circular economy where nothing may go to waste. This eco-friendly approach—of generating and using fuels from plastic waste, simultaneously reduces reliance on fossil fuels and helps mitigate the environmental impact of plastic waste.

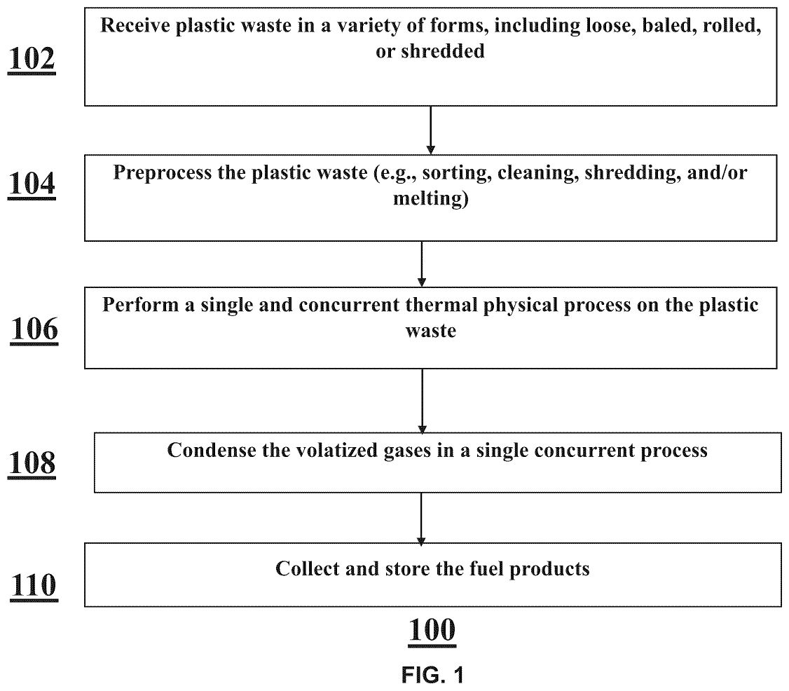

FIG. 1 shows an illustrative method 100 of converting plastic waste to fuels, based on the principles disclosed herein. The steps of method 100 shown in FIG. 1 and described herein are merely examples and should not be considered limiting. That is, methods with additional, alternate, or fewer number of steps should be considered within the scope of this disclosure.

The method may begin at step 102, where plastic waste is received. The plastic waste may arrive in a variety of forms, including loose, baled, rolled, or shredded. The arriving loads may be weighed for billing and recordkeeping purposes. Additionally, an automated sorting system (e.g., combined with an automated contaminant detection system described below) may sort the plastic waste according to the plastic type. The sorting may aid a more optimal shredding, based on the plastic type. In one or more embodiments, different types of plastic waste may be mixed in different ratios based on the characteristics of the end fuel-product.

At step 104, the received plastic waste may be preprocessed. The preprocessing may include sorting, cleaning, shredding, and/or melting. For example, contaminants from the plastic waste may be removed and the plastic waste may be shredded. For instance, collected plastic waste may be inspected visually and with contaminant identifying and removal equipment. Then, the plastic waste may be shredded into smaller pieces or chips. In one or more embodiments, an automated contaminant detection system may be used. The automated contaminant detection system may automatically detect and identify contamination in plastic waste and may allow for a more precise identification and removal of non-processible materials. In one or more embodiments, the automatic contaminant detection system may include a magnetic scanner, which may detect and remove metal and metallic parts from the collected plastic waste.

The shredding may be performed by improved systems with better design, increased horsepower, size, and/or throughput capacity. Additionally, special alloy-based, high strength blades may be used for the shredding. The shredding generates small pieces or chips from the plastic waste.

The sorted, clean and shredded plastic waste may be mechanically preheated and fed to a reformer in melted form to perform the next step (Reformation).

At step 106, a single and concurrent thermal physical process may be performed on the plastic waste. The single and concurrent thermal physical process may be performed without the need for catalyst materials. In one or more embodiments, the single and concurrent thermal physical process may be performed by using a Non-Catalytic Reformation System (NCR). In one or more embodiments, the shredded plastic may be conveyed into a reformer of the NCR system by a pneumatic blower, or conveyer system. The pneumatic blower or conveyer system may allow for a greater mass loading and also may diminish the amount of time to load and restart the reformer. The pneumatic blower and the conveyer system are just examples and any kind of a mechanical system that moves the shredded plastic to the reformer should be considered within the scope of this disclosure.

The NCR process, i.e., process performed by the NCR system, may generally include heating to a high temperature (also known as super heating) the shredded waste plastic in an oxygen free environment. The high temperature may cause the plastic waste to volatize into a gas. In one or more embodiments, the reformer may have high-performance insulation to improve energy conversion and reduce pre-heating time. The furnaces around the reformer may be strengthened. The reformer's liner and insulation may have enhanced security features. Additionally, the reformer may be built using improved, high-temperature stainless steel joined together with improved welding techniques.

In one or more embodiments, the reformer may include an automated thermodynamic control system. For instance, all major separation units in the NCR system may be equipped with phase-controlled-loop (PCL) to manage cooling liquids and heating elements which allows for exact temperature control during the reformation process. By being automated, the thermodynamic control system may lower the labor requirements, reduce fuel consumption for the heating process and improve the quality of the sustainable fuels produced.

In one or more embodiments, the reformer may include an emergency and/or preventive gas evacuation and clean-up system. This system may shorten the reformer loading times and also may eliminate residual gas discharge to the atmosphere. The NCR system may further include residue removal equipment, which in turn may include a pneumatic vacuum system to remove ash and char after each batch.

At step 108, the volatized plastic waste (e.g., in gaseous form) may be concurrently condensed. That is, the produced gas may then be cooled down at specific temperatures and pressure levels and condensed concurrently in a series of individualized condensing units, each designed to generate a specific end-product. The end products may include, but are not limited to, paraffin, diesel, heavy diesel, gasoline fuels, and liquid petroleum gas (LPG). The LPG is recycled back into the system as fuel for heating to create the reformation reaction. A condensing system, performing such condensation, may be expanded, which may allow multiple batches to run in parallel, significantly increasing system output. The condensing system may be a part of the NCR system. That is, the NCR system may include both the reformers and the condensing system.

At step 110, the fuel products generated by condensation may be collected and stored. Each fuel product may be separately conveyed to holding tanks for testing and storage. The transfer, storage, and load-out systems may be designed to detect and contain emissions that could be generated by leaks or spills. Special additives may be blended in, if and as needed, to adjust each fuel as necessary to meet market requirements.

In one or more embodiments, gas recovery systems may be implemented in conjunction with method 100. For example, method 100 may utilize its own produced LPG gas as fuel to heat the reformers. The emissions may be scrubbed by an activated carbon bed. Additionally, leak detection, containment, volume, pressure, and temperature controls may be installed at each of the fuel collection, storage, and load out systems.

In one or more embodiments, safety systems may be implemented in conjunction with method 100. For example, fire suppression systems may be implemented. The fire suppression systems may include nitrogen fire suppression and explosion suppression systems. Additionally, pressure safety valves may be added as pressure relief on all processing vessels involved. Any gas release could be captured and passed through a liquid cooling system and activated carbon filters to mitigate chemical releases.

In one or more embodiments, a residual management system may be implemented. For example, the NCR process may generate a solid residue, approximately 2 to 3% by weight of the incoming plastic waste. The residue may be removed and used for various purposes such as soil amendment augmentation or landfilled.

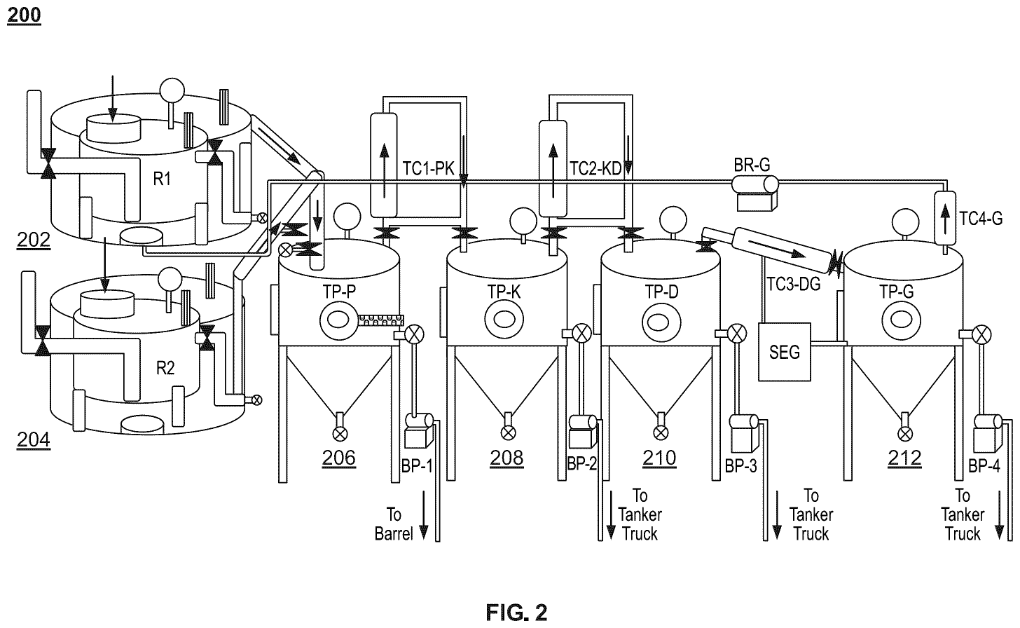

FIG. 2 shows a system 200 for converting plastic waste to fuels, based on the principles disclosed herein. The system 200 may implement the steps of the method 100. It is to be understood that the different components of the system 200 are merely examples, and systems with additional, alternative, and fewer number of components should be considered to be within the scope of this disclosure.

As shown, system 200 may include reformers 202, 204 (just as an example, any number of reformers should be considered within the scope of this disclosure). As described above, reformers 202, 204 may heat shredded plastic waste in an oxygen free environment. The reformers 202, 204 may form a part of an NCR system that performs the NCR process described above. The heating may generate gas that may be cooled in individualized condensing units 206, 208, 210, 212. The individualized condensing units 206, 208, 210, 212 may also be a part of the NCR system. In a non-limiting example, condensing unit 206 may generate paraffin from the gas; condensing unit 208 may generate heavy diesel from the gas; condensing unit 210 may generate diesel from the gas; and condensing unit 212 may generate gasoline (petrol) from the gas. Different embodiments used for improving the method 100 discussed above may be applied to system 200.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. A method of generating fuels from plastic waste, the method comprising:
preprocessing the plastic waste;
mechanically introducing the preprocessed plastic waste into one or more reformers;
heating the preprocessed waste plastic by the one or more reformers in a non-catalytic oxygen free environment to volatize the preprocessed plastic waste to a gas; and
condensing the gas concurrently in a plurality of condensing units to generate a plurality of fuel types, each condensing unit generating a corresponding fuel type.

2. The method of claim 1, heating the preprocessed plastic waste comprising:
heating the preprocessed plastic waste using an automated thermodynamic control system.

3. The method of claim 1, heating the preprocessed plastic waste comprising:
heating the preprocessed plastic waste in multiple parallel reformers including the one or more reformers.

4. The method of claim 1, heating the preprocessed plastic waste comprising:
heating the preprocessed plastic waste in the one or more reformers built using high-temperature stainless steel.

5. The method of claim 1, heating the preprocessed plastic waste comprising:
heating the preprocessed plastic waste in the one or more reformers having high-performance insulation.

6. The method of claim 1, heating the preprocessed plastic waste comprising:
heating the preprocessed plastic waste in the one or more reformers using at least one of the plurality of fuel types.

7. The method of claim 1, the plurality of fuel types comprising at least one of paraffin, heavy diesel, diesel, gasoline, and liquid petroleum gas.

8. The method of claim 1, preprocessing the plastic waste comprising:
shredding the plastic waste by alloy-based blades.

9. The method of claim 1, preprocessing the plastic waste comprising:
preheating the plastic waste.

10. The method of claim 1, mechanically introducing the preprocessed plastic waste into the one or more reformers comprising:
pneumatically blowing the preprocessed plastic waste into the one or more reformers.

11. A system comprising:
one or more reformers configured to:
receive a mechanically introduced preprocessed plastic waste;
heat the preprocessed plastic waste in a non-catalytic oxygen free environment to volatize the preprocessed plastic waste to a gas; and
a plurality of condensing units configured to:
condense the gas concurrently to generate a plurality of fuel types, each condensing unit generating a corresponding fuel type.

12. The system of claim 11, the one or more reformers configured to:
heat the preprocessed plastic waste using an automated thermodynamic control system.

13. The system of claim 11, the one or more reformers configured to:
heat the preprocessed plastic waste in parallel.

14. The system of claim 11, the one or more reformers being built using high-temperature stainless steel.

15. The system of claim 11, the one or more reformers having high-performance insulation.

16. The system of claim 11, the one or more reformers configured to heat the preprocessed plastic waste using at least one of the plurality of fuel types.

17. The system of claim 11, the plurality of fuel types comprising at least one of paraffin, heavy diesel, diesel, gasoline, and liquid petroleum gas.

18. The system of claim 11, the preprocessed plastic waste comprising shredded plastic waste.

19. The system of claim 11, the preprocessed plastic waste comprising preheated plastic waste.

20. The system of claim 11, the one or more reformers configured to receive pneumatically blown preprocessed plastic waste.
